(19) United States
(12) Patent Application Publication
(10) Pub. No.: US 2014/0214806 A1
(43) Pub. Date: Jul. 31, 2014

(54) INFREQUENCY CALCULATING DEVICE, INFREQUENCY CALCULATING METHOD, INTEREST DEGREE CALCULATING DEVICE, INTEREST DEGREE CALCULATING METHOD, AND PROGRAM

(71) Applicant: PANASONIC CORPORATION, Osaka (JP)

(72) Inventor: Yoshifumi SAKATA, Osaka (JP)

(73) Assignee: PANASONIC CORPORATION, Osaka (JP)

(21) Appl. No.: 13/975,984

(22) Filed: Aug. 26, 2013

(30) Foreign Application Priority Data
Jan. 28, 2013 (JP) 2013-012837
Jul. 24, 2013 (JP) 2013-154003

(51) Int. Cl. G06F 17/30

(52) U.S. Cl. CPC G06F 17/30979
USPC 707/722

(57) ABSTRACT

An infrequency calculating device includes: an keyword obtaining unit configured to obtain a target keyword from a content item; a target content counting unit configured to count the number of target content items which satisfy a condition corresponding to the target keyword, among a plurality of content items including the content item; a specific content counting unit configured to count the number of specific content items including the target keyword, among the target content items; and an infrequency calculating unit configured to calculate an infrequency of appearance of the target keyword based on the number of target content items and the number of specific content items.

### CROSS REFERENCE TO RELATED APPLICATIONS

The present application is based on and claims priority of Japanese Patent Application No. 2013-012837 filed on Jan. 28, 2013 and Japanese Patent Application No. 2013-154003 filed on Jul. 24, 2013. The entire disclosures of the above-identified applications, including the specifications, drawings and claims are incorporated herein by reference in their entirety.

### FIELD

The present disclosure relates to an infrequency calculating device, an infrequency calculating method, an interest degree calculating device, an interest degree calculating method, and a program.

### BACKGROUND

Non-Patent Literature (NPL) 1 discloses a technique for calculating a term frequency-inverse document frequency (TF-IDF) which is a degree of importance of a keyword, for the purpose of extracting the keyword from content.

Moreover, Patent Literature (PTL) 1 discloses a technique for extracting a keyword having a high degree of importance from a dialogue based on the TF-IDF taking data in a predetermined period in the past as a parameter, and displaying an advertisement corresponding to the extracted keyword.

### CITATION LIST

### Patent Literature

[PTL 1] Japanese Unexamined Patent Application Publication No. 2009-238199

### Non Patent Literature

“tf-idf,” [online], Sep. 12, 2012, the Internet (http://ja.wikipedia.org/wiki/Tf-idf)

### SUMMARY

### Technical Problem

The present disclosure provides an infrequency calculating device which appropriately determines a degree of importance of a keyword in plural content items including content items which increase in number over time.

### Solution to Problem

The infrequency calculating device according to the present disclosure includes: an obtaining unit configured to obtain a target keyword from a content item; a target content counting unit configured to count the number of target content items which satisfy a condition corresponding to the target keyword, among a plurality of content items including the content item; a specific content counting unit configured to count the number of specific content items including the target keyword, among the target content items; and an infrequency calculating unit configured to calculate an infrequency of appearance of the target keyword based on the number of target content items and the number of specific content items.

### Advantageous Effects

The infrequency calculating device according to the present disclosure is capable of appropriately determining a degree of importance of a keyword in plural content items including content items which increase in number over time.

### BRIEF DESCRIPTION OF DRAWINGS

These and other advantages and features of the disclosure will become apparent from the following description thereof taken in conjunction with the accompanying drawings that illustrate a specific embodiment of the present disclosure.

[FIG. 1A] FIG. 1A is a diagram showing a first example of input data for a television according to a related art.

FIG. 1B is a diagram showing a second example of the input data for the television according to the related art.

FIG. 2 is a diagram showing examples of calculations of a TF-IDF value and a degree of interest according to the related art.

FIG. 3 is a diagram showing a display example of an advertisement according to Embodiment 1.

FIG. 4 is a first block diagram showing a configuration of an infrequency calculating device according to Embodiment 1.

FIG. 5A is a first flowchart showing processing performed by the infrequency calculating device according to Embodiment 1.

FIG. 5B is a second flowchart showing the processing performed by the infrequency calculating device according to Embodiment 1.

FIG. 5C is a third flowchart showing the processing performed by the infrequency calculating device according to Embodiment 1.

FIG. 6 is a diagram showing examples of calculations of a TF-IDF and a degree of interest according to Embodiment 1.

FIG. 7 is a second block diagram showing a configuration of an infrequency calculating device according to another embodiment.

FIG. 8 is a third block diagram showing a configuration of an infrequency calculating device according to another embodiment.

### DESCRIPTION OF EMBODIMENTS

Hereinafter, details of a non-limiting embodiment are described with reference to the drawings. It is to be noted that detailed descriptions beyond necessity may be omitted. For example, details of well-known matters and overlapped descriptions for substantially the same configuration may be omitted. This is for preventing the following description from being unnecessarily lengthy and facilitating understanding of a person skilled in the art.

It is to be noted that the accompanying drawings and the following descriptions are provided by the inventor so that a person skilled in the art sufficiently understands the present disclosure, and are not intended to limit the scope of the subject matter recited in the Claims.

First, problems to be solved by the present disclosure are described in detail.

A TF-IDF is known as a common method to calculate a degree of importance of a keyword for extracting the keyword from content (books, articles, etc). In the TF-IDF, the degree of importance of the keyword is calculated by multiplying a TF value (term frequency) by an IDF value (inverse document frequency). In the IDF, the degree of importance of a term that is present only in some of content items is set to be high. That is to say, the IDF indicates an infrequency of appearance of the term.

The TF-IDF is calculated by Expressions 1, 2, and 3.

TF-IDF(w,d)=TF(w,d)×IDF(w) (Expression 1)

TF(w,d)=the number of appearances of a term w in a content item d/the total number of terms in all content items (Expression 2)

IDF(w)=Log(total number of content items/number of content items including the term w (Expression 3)

Moreover, PTL 1 discloses a technique for extracting a keyword having a high degree of importance from a dialogue based on the TF-IDF taking data in a predetermined period in the past as a parameter (population), and displaying an advertisement corresponding to the extracted keyword.

The present disclosure provides an infrequency calculating device which appropriately determines a degree of importance of a keyword in plural content items including content items which increase in number over time. The following describes the problems to be solved.

In the case of extracting a keyword using the TF-IDF taking content items such as a dialogue, television broadcasting content, etc. which increase in number over time as a parameter, there is a problem that the IDF value of a new keyword is overrated and thus the degree of importance of the new keyword or a degree of interest of a user toward the new keyword is determined to be high.

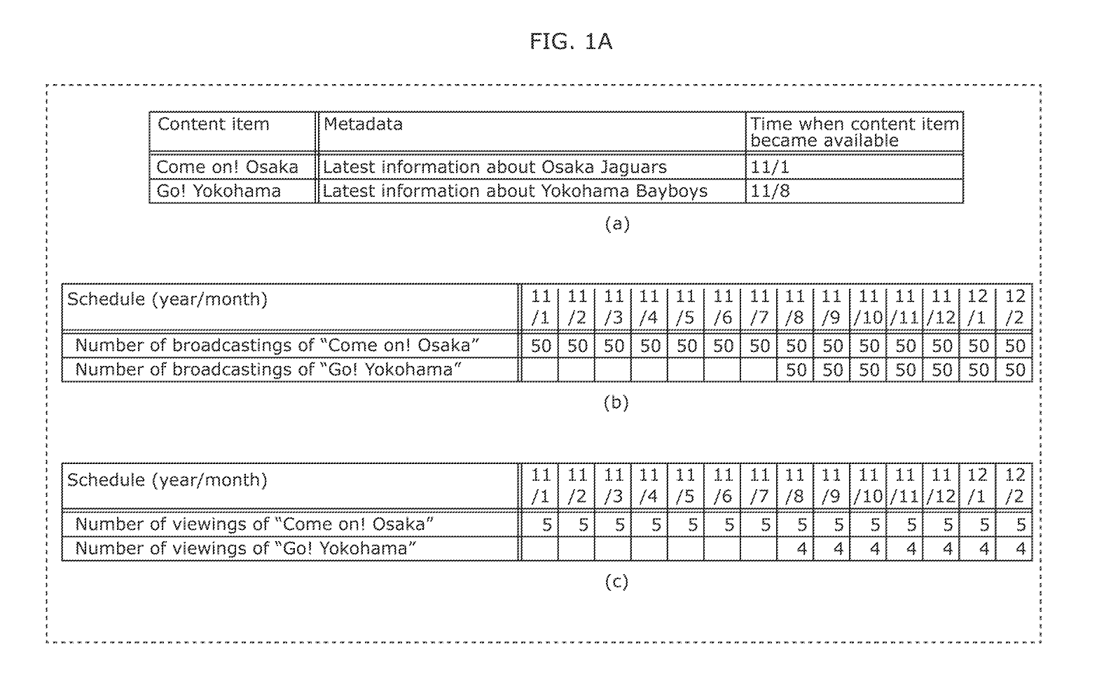

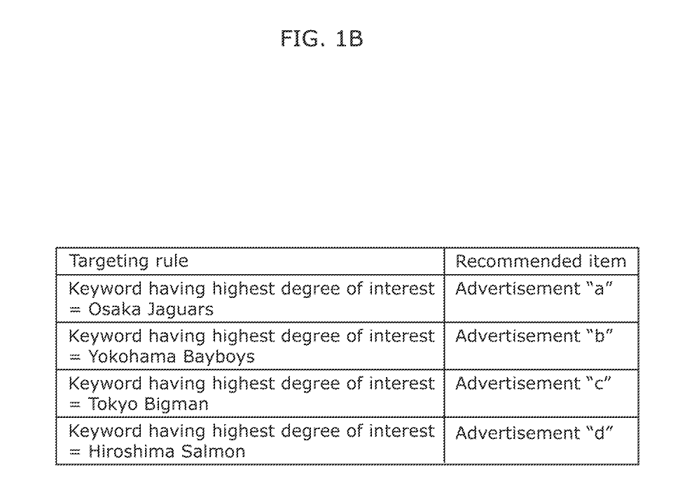

The following describes this problem with reference to a related art exemplified in FIGS. 1A, 1B, and 2.

FIGS. 1A and 1B are diagrams showing examples of input data for a television according to the related art.

When extracting a keyword from a viewing history of a content item, a television extracts the keyword from metadata of the content item shown in (a) in FIG. 1A as shown in (a) in FIG. 2. That is, the television extracts a keyword “Osaka Jaguars” which corresponds to a content item “Come on! Osaka” shown in (a) in FIG. 2 from metadata “Latest information about Osaka Jaguars” assigned to a content item “Come on! Osaka” shown in (a) in FIG. 1A. Moreover, the television extracts a keyword “Yokohama Bayboys” which corresponds to content item “Go! Yokohama” shown in (a) in FIG. 2 from metadata “Latest information about Yokohama Bayboys” assigned to content item “Go! Yokohama” shown in (a) in FIG. 1A.

It is to be noted that the television may obtain the metadata of the content item from a provider of the metadata, or use program data included in an electronic program guide (EPG). A method for obtaining the metadata of the content item is not particularly specified. Moreover, other methods for extracting the keyword from the metadata of the content item include extraction of a noun from a result of a morphological analysis.

In (a) in FIG. 2, for simplicity, the case is shown where only one keyword is included in a single content item and all content items have a TF value of one. That is, only one keyword “Osaka Jaguars” is included in the content item “Come on! Osaka,” and only one keyword “Yokohama Bayboys” is included in the content item “Go! Yokohama.” Thus, each of “Osaka Jaguars” and “Yokohama Bayboys” has a TF value of one.

In (b) in FIG. 1A, broadcasting states of two content items are shown. “Come on! Osaka” has been broadcasted for 14 months, from 11/1 to 12/2, 50 times per month, and “Go! Yokohama” has been broadcasted for 7 months, from 11/8 to 12/2, 50 times per month. It is to be noted that “11/1,” “11/8,” “12/2,” etc. each indicates “the last two digits of the year in the Western calendar/month.” In other words, “11/1,” “11/8,” and “12/2” mean January 2011, August 2011, and February 2012, respectively. This applies throughout the description.

In this case, the IDF values of “Osaka Jaguars” and “Yokohama Bayboys” are calculated as below. When a parameter of the IDF is set to the total number of content items from 14 months ago (11/1) to the present (12/2), the total number of content items is 1050 (=50×14 (total number of broadcasting of “Come on! Osaka”)+50×7 (total number of broadcasting of “Go! Yokohama”)) as shown in (c) in FIG. 2. Moreover, as for the number of content items including each keyword, “Osaka Jaguars” is 700 (=50×14×1) and “Yokohama Bayboys” is 350 (=50×7×1). Thus, as a result of Expression 3, IDF values of “Osaka Jaguars” and “Yokohama Bayboys” are 0.18 and 0.48, respectively, as shown in (e) in FIG. 2.

Moreover, (c) in FIG. 1A shows that the user has viewed “Come on! Osaka” 5 times in each month for 14 months, from 11/1 to 12/2, and has viewed “Go! Yokohama” 4 times in each month for 7 months, from 11/8 to 12/2. In this case, since “Come on! Osaka” (5 times per month) is continuously viewed more frequently compared to “Go! Yokohama” (4 times per month) even after 11/8 when “Go! Yokohama” is stared to be broadcasted, it is appropriate to determine the content item in which the user is interested is still “Come on! Osaka.”

However, in the conventional TF-IDF as shown in (e) in FIG. 2, there is a problem that the degree of interest in the keyword “Yokohama Bayboys” is calculated to be higher than that in “Osaka Jaguars” unlike the above determination. A reason why the degree of interest in “Yokohama Bayboys” which is a new keyword is calculated to be high is that the IDF value of “Yokohama Bayboys” is considerably higher than the IDF value of “Osaka Jaguars” which has been present from the time before the appearance of “Yokohama Bayboys.”

Here, the degree of interest is calculated by Expression 4 in the above example. The degree of interest increases as the user views a content item including a keyword having a higher degree of importance more frequently. That is to say, the degree of interest has a large value for a keyword which is viewed by the user with more interest compared to other keywords.

degree of interest=degree of importance(TF-IDF value)×total number of viewings (Expression 4)

The television presents to the user an advertisement related to a keyword in which the user is interested, with reference to an association table between targeting rules and recommended items shown in FIG. 1B. When the degree of interest in “Yokohama Bayboys” exceeds the degree of interest in “Osaka Jaguars” as described above, an advertisement “b” related to “Yokohama Bayboys” is shown to the user. However, since the user is in fact considered to be more interested in “Osaka Jaguars” than “Yokohama Bayboys,” it is appropriate to present an advertisement “a” related to “Osaka Jaguars.”

In view of this, the present disclosure provides an infrequency calculating device which appropriately determines a degree of importance of a new keyword in plural content items including content items which increase in number over time.

### Embodiment 1

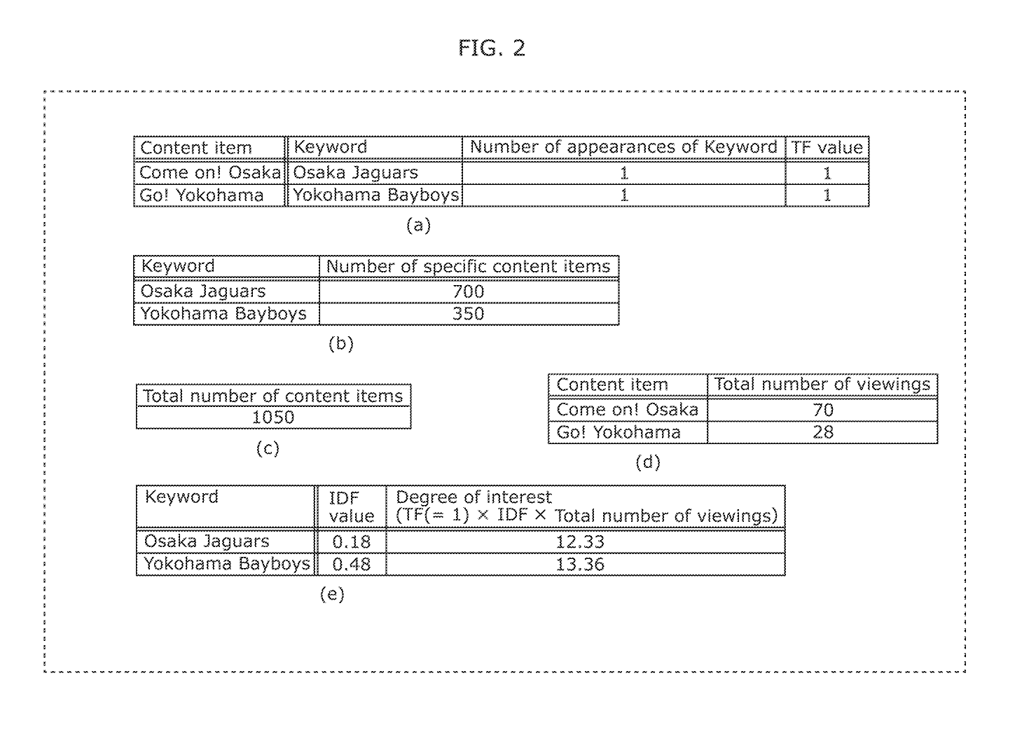

The following describes non-limiting Embodiment 1 with reference to FIGS. 3 to 6.

FIG. 3 is a diagram showing a display example of an advertisement according to Embodiment 1. The following describes the display example of the advertisement on a screen of a display device (television) with reference to FIG. 3. In (a) in FIG. 3, a display device 100 which displays broadcast video is shown. When the user who is currently viewing the broadcast video pushes a menu button 111 on a remote controller 110 intending to refer to other content items that are available using the display device 100 while the display device 100 is displaying the broadcast video, in addition to “television broadcasting”, menu items such as “recorded content item,” “VoD (cinema),” and “Web” which are available using the display device 100 are displayed on the display device 100 as shown in (b) in FIG. 3. Moreover, the display device 100 displays an advertisement 300 matching with the keyword in which the user is interested in, other than the menu items.

In this embodiment, the display device which is capable of replacing the advertisement 300 with an advertisement that is more appropriate to the interest of the user. It is to be noted that the display example of the advertisement is not limited to the example shown in FIG. 3. For example, the advertisement 300 may be present when frequent channel operations (zapping) longer than or equal to a predetermined period or more than or equal to a predetermined times are detected.

### 1. Configuration

### [1-1. A Configuration of an Infrequency Calculating Device]

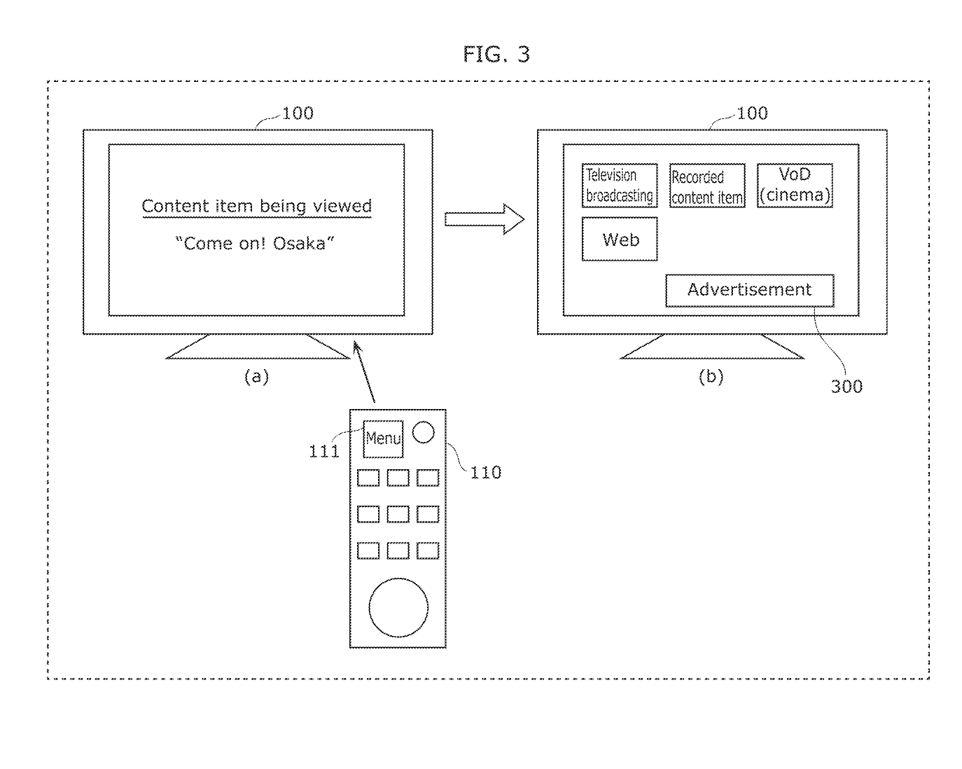

FIG. 4 is a block diagram showing a configuration of an infrequency calculating device 1 according to this embodiment. As shown in FIG. 4, the infrequency calculating device 1 includes a keyword obtaining unit 10, a target content counting unit 20, a specific content counting unit 21, an infrequency calculating unit 22, a target keyword counting unit 30, a number-of-viewings obtaining unit 40, an interest degree calculating unit 50, a recommended item selecting unit 60, and a recommended item display unit 70. It is to be noted that the infrequency calculating device 1 may be implemented in the display device 100 as a function, or may be implemented as the display device 100 itself.

The keyword obtaining unit 10 is a processing unit which extracts (obtains) a keyword from an available content item that can be viewed. The keyword obtaining unit 10 obtains metadata assigned to the available content item and extracts the keyword from the obtained metadata. Here, the keyword obtaining unit 10 may obtain the metadata of the available content item from a server of a provider of the metadata via a network connector (not shown), or may use program data included in an EPG superimposed on broadcast waves as the metadata. A method for obtaining the metadata of the available content item is not particularly specified. Moreover, an example of the method for extracting the keyword from the metadata of the content item includes extraction of a noun from a result of a morphological analysis. It is to be noted that the keyword obtaining unit 10 corresponds to an obtaining unit. It is to be noted that “content item” means a television broadcasting content item or a video content item recorded on a recording media (for example, a video on demand (VoD) content item, or a content item which is recorded from television broadcasting), and includes meta information indicating details of such content items.

The target content counting unit 20 is a processing unit which counts the number of target content items which satisfies conditions corresponding to the keyword. “A target content item which satisfies conditions corresponding to the keyword” is, for example, a content item which has became available during the time period from the time when the keyword first appeared till the present. The number of target content items is also referred to as the total number of content items for each keyword. Here, the time when the keyword first appeared means that the time when the content item including the keyword as metadata became available to the user at the first time. Specifically, in the case where the content item is a television broadcasting content item, the time when the keyword first appeared is the time when the television broadcasting content item is broadcasted for the first time. Moreover, in the case where the content item is a VoD content item, the time when the keyword first appeared is the time when the VoD content item became available in the VoD service for the first time. In other words, the available content item means the content item available as a target for which an infrequency of appearance is calculated by the infrequency calculating device 1. Moreover, the time when the keyword first appeared means the time when the keyword became available as a target for which an infrequency of appearance is calculated by the infrequency calculating device 1.

The specific content counting unit 21 is a processing unit which counts the number of specific content items that are content items including the keyword. The number of specific content items is also referred to as the number of content items for each keyword. The specific content counting unit 21 is the same as a processing unit which calculates a numerator in the Log of Expression 3 which is a conventional expression for determining an IDF value.

The infrequency calculating unit 22 is a processing unit which calculates the IDF value according to the present disclosure by Expression 5 using the number of target content items counted by the target content counting unit 20 and the number of content items counted by the specific content counting unit 21.

IDF value according to the present disclosure=Log(number of target content items/number of specific content items) (Expression 5)

The target keyword counting unit 30 is a processing unit which calculates a frequency of appearance of the keyword for each content item. The target keyword counting unit 30 is the same as a processing unit which calculates a conventional TF value by Expression 2. It is to be noted that the logarithm is taken of the ratio between the number of target content items and the number of specific content items, but the same advantage is obtained without taking the logarithm. That is, by taking the logarithm, a variation rate of the IDF can be decreased relative to a variation rate of (the number of target content items/the number of specific content items) when (the number of target content items/the number of specific content items) is larger than one, but it is not necessarily needed to decrease the variation rate of the IDF. Therefore, the infrequency calculating unit 22 is capable of calculating an appropriate infrequency without taking the logarithm.

The number-of-viewings obtaining unit 40 is a processing unit which obtains the number of times the user viewed each content item. The number-of-viewings obtaining unit 40 obtains the number of viewings which is the number of times the television broadcasting content item is viewed based on the result of a selection of a tuner (not shown). Moreover, the number-of-viewings obtaining unit 40 may obtain the number of viewings for the VoD content item viewed via the network connector (not shown). Furthermore, the number-of-viewings obtaining unit 40 may obtain the number of viewings for the web content item accessed via the network connector (not shown).

The interest degree calculating unit 50 is a processing unit which estimates the degree of interest of the user by the same calculation as Expression 4. The interest degree calculating unit 50 performs the calculation of Expression 4 using the TF value calculated by the target keyword counting unit 30 and the IDF value according to the present disclosure calculated by the infrequency calculating unit 22. Moreover, the interest degree calculating unit 50 uses the number of viewings for each content item obtained by the number-of-viewings obtaining unit 40 as the total number of viewings in Expression 4.

The recommended item selecting unit 60 is a processing unit which selects an advertisement matching a targeting rule. Upon receiving an inquiry for a recommended item from a recommended item display unit 70, the recommended item selecting unit 60 transmits the recommended item to the recommended item display unit 70 in response to the inquiry. The targeting rule and the recommended item are obtained from an advertisement providing server etc. on the network via the network connector (not shown).

The recommended item display unit 70 is a processing unit which displays the recommended item. Specifically, after receiving a recommended item displaying trigger, for example, after a menu button 111 is pressed on a remote controller 110, the recommended item display unit 70 inquires of the recommended item selecting unit about the recommended item to be displayed. The recommended item display unit 70 receives the recommended item transmitted by the recommended item selecting unit 60 in response to the inquiry, and display the recommended item. In this embodiment, the recommended item is an advertisement.

### 2. Operation

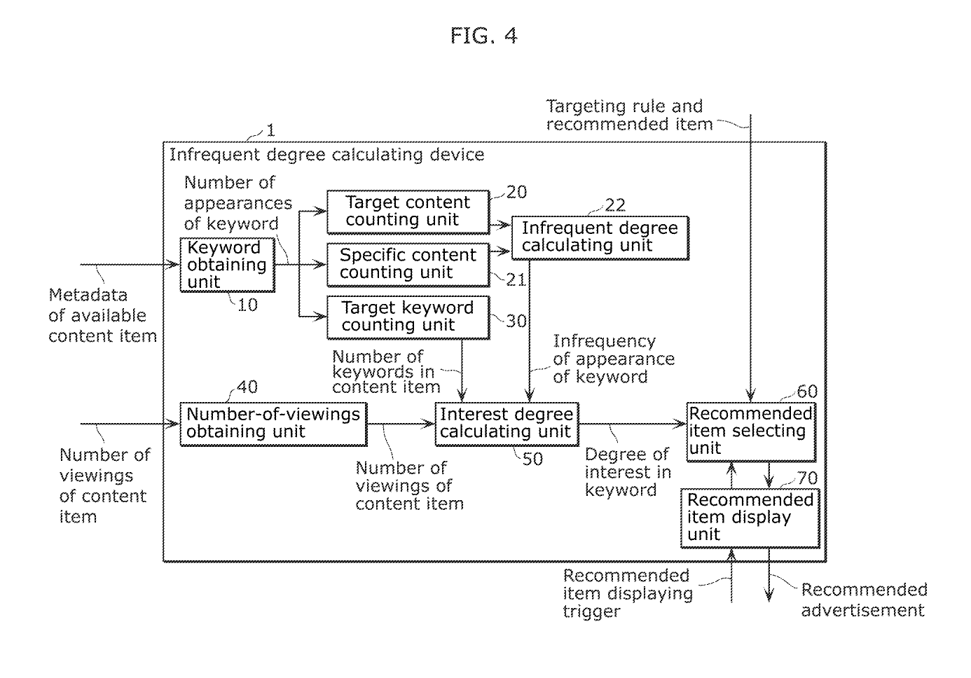

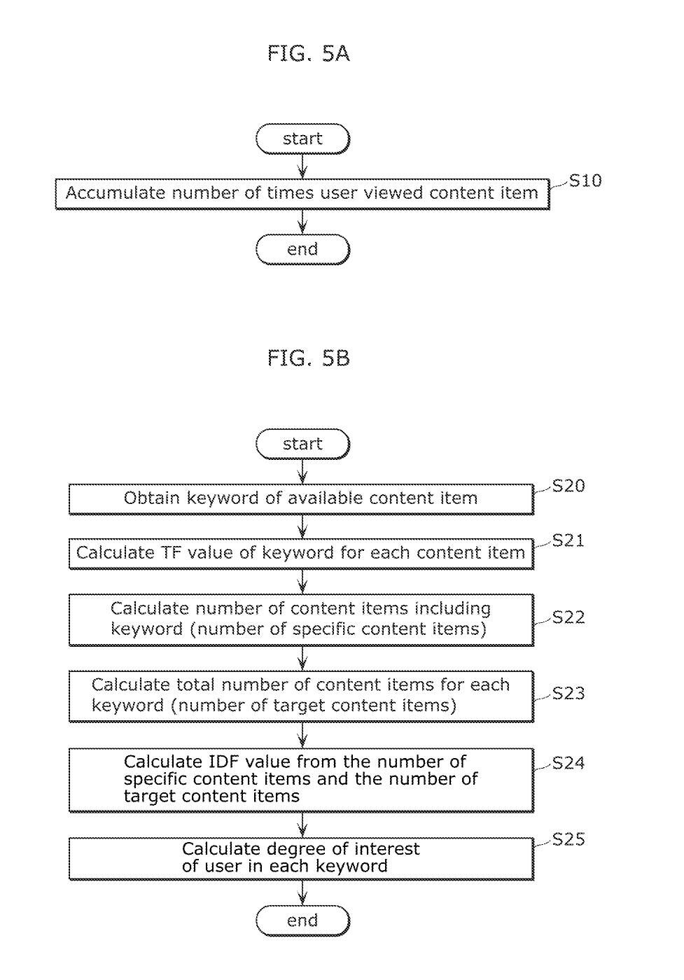

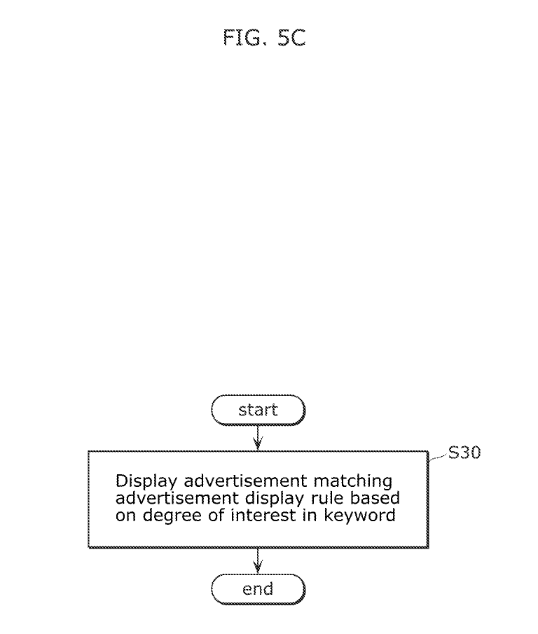

The processing performed by the infrequency calculating device 1 configured as above is described with reference to FIGS. 5A, 5B, and 5C. FIGS. 5A, 5B, and 5C are flowchart showing the processing performed by the infrequency calculating device 1.

FIG. 5A shows processing performed by the infrequency calculating device 1 at the time when the user views the content item. FIG. 5B shows processing performed by the infrequency calculating device 1 at the time when the degree of interest of the user in the keyword is updated. FIG. 5C shows processing performed by the infrequency calculating device 1 at the time when the recommended item displaying trigger is received.

The available content items used in the description of the operation in this embodiment are “Come on! Osaka” and “Go! Yokohama” shown in (a) in FIG. 1A, and the number of broadcastings of each available content item per month is as shown in (b) in FIG. 1A. Moreover, the number of times the user views each content item per month is as shown in (c) in FIG. 1A. Furthermore, the targeting rule and the recommended item is as shown in FIG. 1B.

As shown in FIG. 5A, in Step S10, the number-of-viewings obtaining unit 40 counts the number of viewings every time the content item is viewed. The result of the counting is accumulated as the total number of viewings for each content item as shown in (d) in FIG. 2. Here, the total number of viewings of “Come on! Osaka” is 70 and the total number of viewings of “Go! Yokohama” is 28.

As shown in FIG. 5B, in Step S20, the keyword obtaining unit 10 obtains a keyword from metadata of the available content item. For example, the keyword obtaining unit 10 extracts the keyword “Osaka Jaguars” from the metadata “Latest information about Osaka Jaguars” which is assigned to the available content item “Come on! Osaka.” Moreover, the keyword obtaining unit 10 extracts the keyword “Yokohama Bayboys” from the metadata “Latest information about Yokohama Bayboys” which is assigned to the available content item “Go! Yokohama.” As a result of such extractions, “keyword” and “the number of appearances of keyword” shown in (a) in FIG. 2 can be obtained.

In Step S21, the target keyword counting unit 30 calculates the TF value of the keyword for each available content item using Expression 2. For example, when the number of appearances of the keyword “Osaka Jaguars” in the available content item “Come on! Osaka” is one and the number of appearances of the keyword “Osaka Jaguars” in the entire available content items is also one, the TF value of “Osaka Jaguars” is one. In the same manner as above, the TF value of “Yokohama Bayboys” is one as shown in (a) in FIG. 2.

In Step S22, the specific content counting unit 21 counts the number of content items including the keyword (the number of specific content items). The specific content counting unit 21 counts the number of content items including the keyword based on the keyword in the available content item shown in (a) in FIG. 2 and the number of broadcastings of the available content item shown in (b) in FIG. 1A. For example, a content item including the keyword “Osaka Jaguars” as metadata is only “Come on! Osaka,” and the number of broadcastings of “Come on! Osaka” is 700 during the period from 11/1 to 12/2, so that the specific content counting unit 21 determines the number of content items corresponding to the keyword “Osaka Jaguars” to be 700. In the same manner as above, a content item including the keyword “Yokohama Bayboys” as metadata is only “Go! Yokohama,” and the number of broadcastings of “Go! Yokohama” is 350 during the period from 11/8 to 12/2, so that the specific content counting unit 21 determines the number of content items corresponding to the keyword “Go! Yokohama” to be 350. Accordingly, the specific content counting unit 21 obtains a value of “the number of specific content items” shown in (b) in FIG. 2.

In Step S23, the target content counting unit 20 counts the total number of content items for each keyword (the number of target content items). For example, in the exemplary data according to this embodiment, the number of appearances of the keyword “Osaka Jaguars” corresponding to “Come on! Osaka” is one, and the number of appearances of the keyword “Yokohama Bayboys” corresponding to “Go! Yokohama” is also one as shown in (a) in FIG. 2. Therefore, the number of viewings of “Come on! Osaka” and the number of appearances of the corresponding keyword “Osaka Jaguars” are the same. Moreover, the number of viewings of “Go! Yokohama” and the number of appearances of the corresponding keyword “Yokohama Bayboys” are the same.

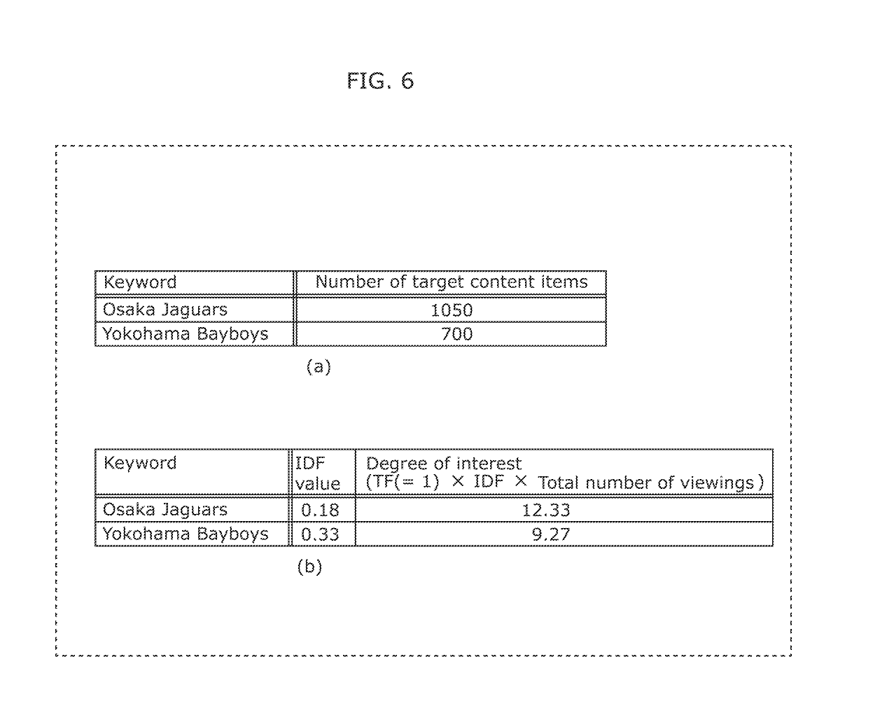

Here, with reference to (b) in FIG. 1A, the total number of content items for the keyword “Osaka Jaguars” is 1050, which is obtained by summing the number of broadcastings of “Come on! Osaka” and “Go! Yokohama” after 11/1 because the time when the “Come on! Osaka” became available for the first time is 11/1. Moreover, the total number of content items for the keyword “Yokohama Bayboys” is 700, which is obtained by summing the number of broadcastings of “Come on! Osaka” and “Go! Yokohama” after 11/8 because the time when the “Go! Yokohama” became available for the first time is 11/8. Accordingly, the target content counting unit 20 obtains the total number of content items for each of the keywords “Osaka Jaguars” and “Yokohama Bayboys” (the number of target content items) as shown in (a) in FIG. 6.

Turning back to FIG. 5B, in Step S24, the infrequency calculating unit 22 calculates the IDF value according to the present disclosure from the number of content items for each keyword and the total number of content items for each keyword. For example, the number of content items for the keyword “Osaka Jaguars” is 700 according to (b) in FIG. 2, and the total number of content items for the keyword “Osaka Jaguars” is 1050 according to (a) in FIG. 6. Thus, the infrequency calculating unit 22 calculates the IDF value with respect to “Osaka Jaguars” according to the present disclosure to be 0.18 by Expression 5 ((b) in FIG. 6). In the same manner as above, the infrequency calculating unit 22 calculates the IDF value with respect to “Yokohama Bayboys” according to the present disclosure to be 0.33.

Here, the results of the calculations of the conventional IDF value shown in (e) in FIG. 2 and the IDF value according to the present disclosure shown in (b) in FIG. 6 are compared. As for the keyword “Osaka Jaguars,” since the conventional total number of content items for each keyword and the total number of content items for each keyword according to this embodiment are the same, both the conventional IDF value and the IDF value according to the present disclosure are 0.18. On the other hand, as for the keyword “Yokohama Bayboys,” since the total number of content items for each keyword according to this embodiment is smaller than the conventional total number of content items for each keyword, the IDF value of 0.33 according to the present disclosure is smaller than the conventional IDF value of 0.48.

In Step S25, the interest degree calculating unit 50 estimates a degree of interest of the user in the keyword according to the present disclosure using Expression 4. For example, in this embodiment, since the content item that includes the keyword “Osaka Jaguars” as metadata is only “Come on! Osaka” and the TF value is one as shown in (a) in FIG. 2, the number of viewings of “Come on! Osaka” and the number of appearances of the corresponding keyword “Osaka Jaguars” are the same. Moreover, the total number of viewings of “Come on! Osaka” is 70 as shown in (d) in FIG. 2, so that the number of appearances of the corresponding keyword “Osaka Jaguars” is 70. Moreover, the TF value of “Osaka Jaguars” is one as shown in (a) in FIG. 2 and the IDF value of the keyword “Osaka Jaguars” according to the present disclosure is 0.18 as shown in (b) in FIG. 6, so that the degree of interest of the user in the keyword “Osaka Jaguars” according to the present disclosure is 12.33.

In the same manner as above, in this embodiment, since the content item that includes the keyword “Yokohama Bayboys” as metadata is only “Go! Yokohama” and the TF value is one as shown in (a) in FIG. 2, the number of viewings of “Go! Yokohama” and the number of appearances of the corresponding keyword “Yokohama Bayboys” are the same. Moreover, the total number of viewings of “Go! Yokohama” is 28 as shown in (d) in FIG. 2, so that the number of appearances of “Yokohama Bayboys” which is a keyword corresponding to “Come on! Osaka” is 28. Moreover, the TF value of “Yokohama Bayboys” is one as shown in (a) in FIG. 2 and the IDF value of the keyword “Yokohama Bayboys” according to the present disclosure is 0.33 as shown in (b) in FIG. 6, so that the degree of interest of the user in the keyword “Yokohama Bayboys” according to the present disclosure is 9.27.

According to (b) and (c) in FIG. 1A, not only during the period from 11/1 to 11/7 when “Come on! Osaka” is broadcasted but “Go! Yokohama” is not broadcasted, but also after 11/8 which is the time when “Go! Yokohama” became available for the first time, the user views “Come on! Osaka” (5 times per month) more frequently than “Go! Yokohama” (4 times per month) ((c) in FIG. 1A) even though the number of broadcastings of “Come on! Osaka” and “Go! Yokohama” are the same (50 times each per month) ((b) in FIG. 1A). Therefore, it is appropriate that the degree of interest in the keyword “Osaka Jaguars” corresponding to “Come on! Osaka” is calculated to be higher than the degree of interest in the keyword “Yokohama Bayboys” corresponding to “Go! Yokohama.” As shown in (e) in FIG. 2, the conventional degree of interest in “Osaka Jaguars” is 12.33, and the conventional degree of interest in “Yokohama Bayboys” is 13.36, which is not appropriate because the degree of interest in “Osaka Jaguars” is calculated to be lower than the degree of interest in “Yokohama Bayboys.” On the other hand, as shown in (b) in FIG. 6, the degree of interest according to the present disclosure in “Osaka Jaguars” is 12.33, and the degree of interest in “Yokohama Bayboys” is 9.27, which is appropriate because the degree of interest in “Osaka Jaguars” is calculated to be higher than the degree of interest in “Yokohama Bayboys.”

The degree of interest described in Steps S20 to S25 in this embodiment is updated every other day. It is to be noted that the degree of interest may be updated at different intervals, for example, may be updated once a week or may be triggered to be updated at the time when the user views the content item, etc.

In Step S30 in FIG. 5C, upon receiving a recommended item displaying trigger, for example, when the menu button 111 of the remote controller 110 is pressed, the recommended item display unit 70 requests the recommended item selecting unit 60 to select an advertisement that is to be presented to the user, and then the recommended item selecting unit 60 selects a recommended item (advertisement) that is to be displayed based on the degree of interest of the user in the keyword and the targeting rule, and notifies the recommended item display unit 70 of the selected recommended item. The recommended item display unit 70 displays the notified recommended item (advertisement) on a screen of the display device 100.

For example, based on the degree of interest of the user in the keyword according to the present disclosure shown in (b) in FIG. 6, and the targeting rule and the recommended item shown in FIG. 1B, an advertisement “a” matching the targeting rule “the keyword having the highest degree of interest=Osaka Jaguars” is displayed, which is an appropriate result. On the other hand, based on the conventional degree of interest of the user in the keyword shown in (e) in FIG. 2, and the targeting rule and the recommended item shown in FIG. 1B, an advertisement “b” matching the targeting rule “the keyword having highest degree of interest=Yokohama Bayboys” is displayed, which is not an appropriate result.

It is to be noted that the infrequency calculating device, the infrequency calculating method, and a program for causing a computer to execute the infrequency calculating method may be implemented as an interest degree calculating device, an interest degree calculating method, and a program for causing a computer to execute the interest degree calculating method, respectively.

### 3. Conclusion

In this embodiment, the infrequency calculating device 1 includes the keyword obtaining unit 10, the target content counting unit 20, the specific content counting unit 21, the infrequency calculating unit 22, the target keyword counting unit 30, the number-of-viewings obtaining unit 40, the interest degree calculating unit 50, the recommended item selecting unit 60, and the recommended item display unit 70.

The target content counting unit 20 counts the number of content items which became available during the period from the time when the keyword newly appeared to the present for each keyword. The specific content counting unit 21 counts the number of content items including the keyword. The infrequency calculating unit 22 calculates the IDF value according to the present disclosure by Expression 5 using the number of target content items counted by the target content counting unit 20 and the number of specific content items counted by the specific content counting unit 21.

The interest degree calculating unit 50 estimates the degree of interest of the user by the same calculation as Expression 4. It is to be noted that, in this case, the calculation of Expression 4 is performed using the TF value calculated by the target keyword counting unit 30 and the IDF value according to the present disclosure calculated by the infrequency calculating unit 22. Moreover, the number of viewings for each content item obtained by the number-of-viewings obtaining unit 40 is used as the total number of viewings in Expression 4.

The recommended item selecting unit 60 selects an advertisement matching the targeting rule.

After receiving the recommended item displaying trigger, for example, after the menu button 111 is pressed on the remote controller 110, the recommended item display unit 70 inquires of the recommended item selecting unit 60 about the recommended item to be displayed. The recommended item display unit 70 receives the recommended item transmitted by the recommended item selecting unit 60 in response to the inquiry, and displays the recommended item.

As described above, the infrequency calculating unit 22 is capable of setting the appropriate IDF value for the new keyword according to the present disclosure by using the total number of content items for each keyword counted by the target content counting unit 20. Thus, the degree of interest of the user can be appropriately calculated, so that presentation of the advertisement according to the interest of the user is enabled.

As described above, the infrequency calculating device according to the present disclosure includes: an obtaining unit configured to obtain a target keyword from a content item; a target content counting unit configured to count the number of target content items which satisfy a condition corresponding to the target keyword, among a plurality of content items including the content item; a specific content counting unit configured to count the number of specific content items including the target keyword, among the target content items; and an infrequency calculating unit configured to calculate an infrequency of appearance of the target keyword based on the number of target content items and the number of specific content items.

With this, the infrequency calculating device is capable of calculating the infrequency of appearance of the target keyword taking a group of content items determined corresponding to the target keyword (target content items) as a population. In the conventional related art, the population for calculating the infrequency of appearance of the target keyword does not depend on the target keyword, but is the whole content items that are present. Therefore, there may be the case where the infrequency of appearance is not correct with respect to content items which increase in number over time. According to the present disclosure, the target content items are narrowed down among the whole content items using conditions that correspond to the increase in the number of content items over time, so that the infrequency of appearance of the content items which increase in number over time can be correctly calculated.

Moreover, it may be that the plurality of content items include content items that newly appear over time, the condition corresponding to the target keyword is that a current content item appears during a period from when a content item including the target keyword appeared till when the target content counting unit counts the number of target content items, and the target content counting unit is configured to count, as the number of target content items, the number of content items that appeared during the period as the number of target content items, among the plurality of content items.

With this, the infrequency calculating device sets the above group of content items according to the time when the content item including the target keyword appeared. That is, the infrequency calculating device calculates the infrequency of appearance of the target keyword taking the content item that appeared during the period from when the content item including the target keyword appeared till when the target content counting unit performs counting. Thus, content items that had appeared before content items including the target keyword appeared can be eliminated from the population. Such elimination can prevent the infrequency of appearance of the target keyword from being calculated to be excessively high.

Moreover, it may be that the plurality of content items include a content item that newly appears over time, the condition corresponding to the target keyword is that a current content item appears during a period from when a predetermined number of content items including the target keyword appeared till when the target content counting unit counts the number of target content items, and the target content counting unit is configured to count, as the number of target content items, the number of content items that appeared during the period as the number of target content items, among the plurality of content items.

With this, as for the target keyword that incidentally appeared few times and then does not appear for a predetermined period, an appearance after the predetermined period can be regarded as a new appearance when calculating the infrequency of appearance of the target keyword. Thus, the infrequency of appearance of the target keyword can be calculated with higher accuracy.

Moreover, the infrequency calculating unit may be configured to calculate the infrequency of appearance of the target keyword using a ratio between the number of target content items and the number of specific content items.

With this, the infrequency calculating device is capable of calculating the infrequency of appearance of the target keyword taking the group of content items which is determined corresponding to the target keyword as the population using the ratio between the number of target content items and the number of specific content items.

Moreover, in the infrequency calculating device according to this embodiment, it may be that the infrequency of appearance of the target keyword is a term frequency-inverse document frequency (TF-IDF) value of the target keyword, and the infrequency calculating unit is configured to calculate the TF-IDF value of the target keyword by Expressions 11, 12, and 13, where A is the number of target content items, B is the number of specific content items, C is the number of target keywords included in the target content items, and D is the number of terms included in the plurality of content items.

IDF value=Log(A/B) (Expression 11)

TF value=C/D (Expression 12)

TF-IDF value=TF value×IDF value (Expression 13)

With this, the infrequency calculating device is capable of calculating the infrequency of appearance of the target keyword using the TF-IDF method.

Moreover, an infrequency calculating method according to this embodiment includes: obtaining a target keyword from a content item; counting the number of target content items which satisfy a condition corresponding to the target keyword, among a plurality of content items including the content item; counting the number of specific content items including the target keyword, among the target content items; and calculating an infrequency of appearance of the target keyword based on the number of target content items and the number of specific content items.

This provides the same advantage as that of the above infrequency calculating device.

Moreover, the program according to this embodiment is a program for causing a computer to execute the above-described infrequency calculating method.

This provides the same advantage as that of the above infrequency calculating device.

Moreover, the interest degree calculating device according to this embodiment includes: the infrequency calculating device according to Claim 1; a number-of-viewings obtaining unit configured to obtain the number of viewings which is the number of times a user viewed the specific content items; and an interest degree calculating unit configured to calculate a degree of interest of the user in the specific content items based on the infrequency of appearance calculated by the infrequency calculating device and the number of viewings obtained by the number-of-viewings obtaining unit.

With this, the interest degree calculating device is capable of calculating the degree of interest which indicates the degree of interest of the user in the content item using the infrequency of appearance calculated by the infrequency calculating device.

Moreover, the interest degree calculating method according to this embodiment includes: the infrequency calculating method according to Claim 6; obtaining the number of viewings which is the number of times a user viewed the specific content items; and calculating a degree of interest of the user in the specific content items based on the infrequency of appearance calculated by the infrequency calculating method and the number of viewings obtained in the obtaining of the number of viewings.

This provides the same advantage as that of the above interest degree calculating device.

Moreover, the program according to this embodiment is a program for causing a computer to execute the above-described interest degree calculating method.

This provides the same advantage as that of the above interest degree calculating device.

### Other Embodiments

Non-limiting Embodiment 1 has been described above as an example of an implementation according to the present disclosure. However, the present disclosure is not limited to these, but can be applicable to embodiments with appropriate modifications, replacement, addition, omission, and others. Moreover, it is also possible to form a new embodiment by combining constituent elements described in the above Embodiment 1.

The following collectively describes other non-limiting embodiments.

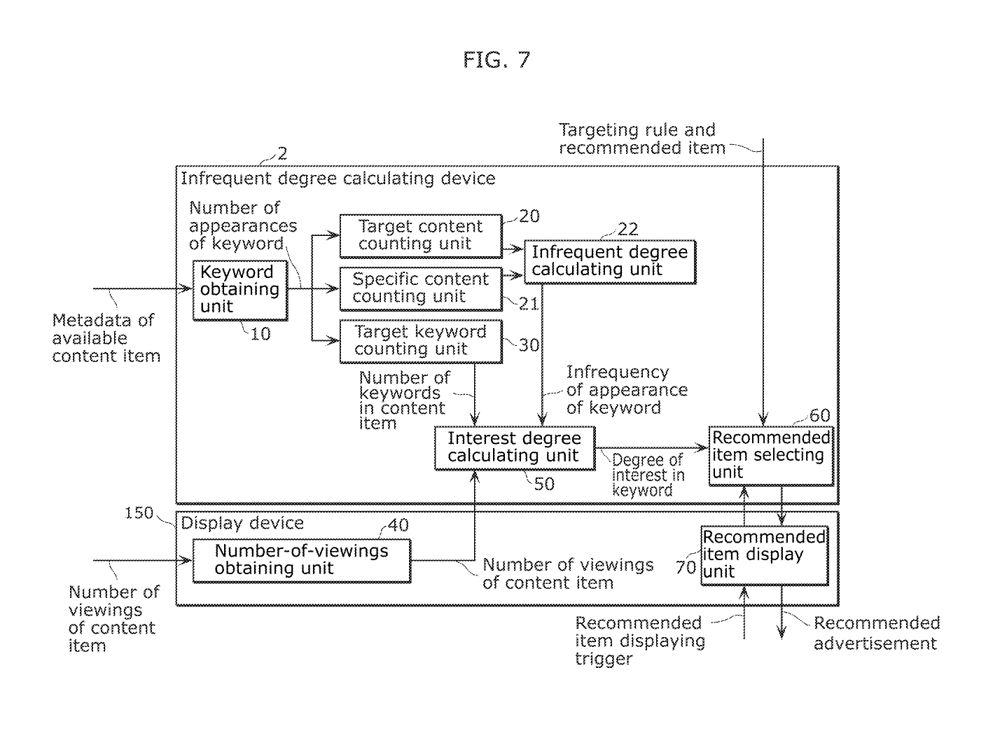

In Embodiment 1, all the functional blocks are held in the infrequency calculating device (television), but the functional blocks may be separately held in plural devices. For example, even though an infrequency calculating device 2 includes the keyword obtaining unit 10, the target content counting unit 20, the specific content counting unit 21, the infrequency calculating unit 22, the target keyword counting unit 30, the interest degree calculating unit 50, and the recommended item selecting unit 60, and a display device 150 includes the number-of-viewings obtaining unit 40 and the recommended item display unit 70 as shown in FIG. 7, the generality of the present disclosure is not impaired and the same advantage is obtained. According to the configuration shown in FIG. 7, a part of processing which is performed in response to actions of the user, for example, in response to a state of viewing or a recommended item displaying trigger is dealt by the display device 150, and the rest of the processing is dealt by the infrequency calculating device 2. With this, the infrequency calculating device 2 can collectively perform processing that is not originating from the actions of the user, such as the processing performed by the infrequency calculating unit 22, thereby providing an advantage that a processing load for the calculations can be reduced.

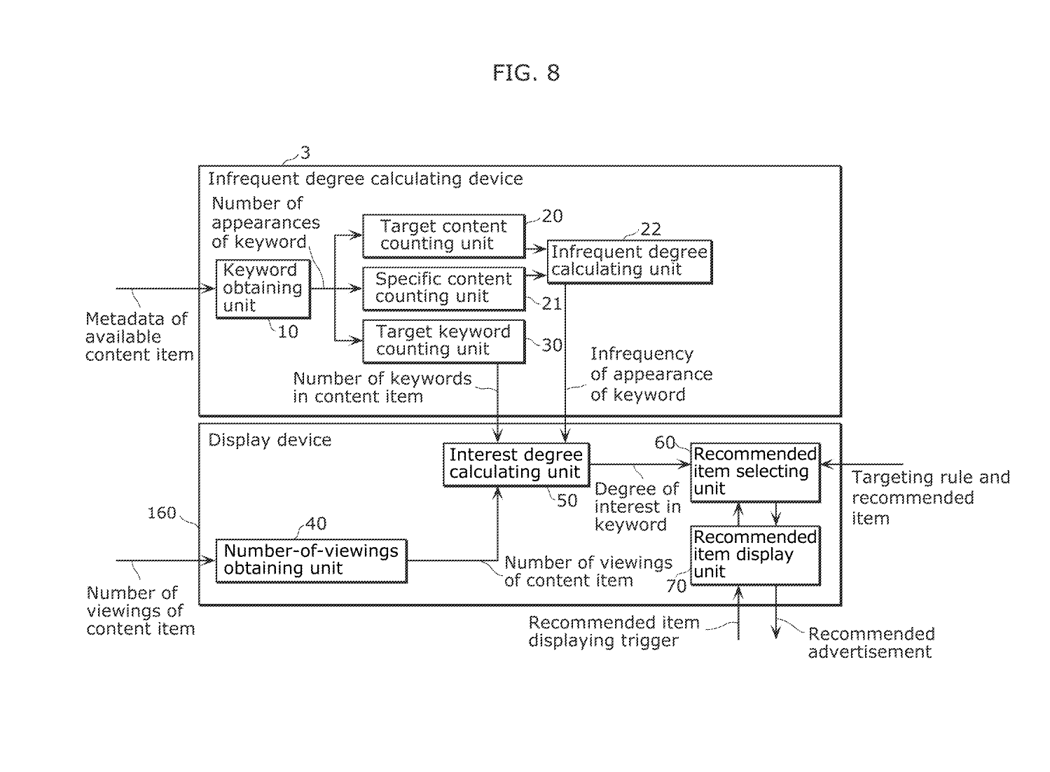

Moreover, for example, even though an infrequency calculating device 3 includes the keyword obtaining unit 10, the target content counting unit 20, the specific content counting unit 21, the infrequency calculating unit 22, the target keyword counting unit 30, and a display device 160 includes the number-of-viewings obtaining unit 40, the interest degree calculating unit 50, the recommended item display unit 60, and the recommended item display unit 70 as shown in FIG. 8, a generality of the present disclosure is not impaired and the same advantage is obtained. According to the configuration shown in FIG. 8, processing which is performed in response to actions of the user, for example, in response to a state of viewing or a recommended item displaying trigger is dealt by the display device 160, and the rest of the processing is dealt by the infrequency calculating device 3. Other than the advantage described with reference to FIG. 7, an advantage is obtained that a processing load for a communication can be reduced because the display device 160 does not transmit data to the infrequency calculating device 3.

It is to be noted that the manner in which the functional blocks are shared by the plural devices is not limited to the example shown in FIG. 7, but an optimal configuration should be conceived based on a form of service provision or a hardware configuration of the television. Moreover, one server may be used, or plural servers may provide services to the television in a coordinated manner.

For facilitating description of the advantage of the present disclosure, the description has been given with reference to the data ((b) and (c) in FIG. 1A) in which the same content item of each of “Come on! Osaka” and “Go! Yokohama” is broadcasted 50 times per month and the user views the content item plural times every month (5 or 4 times). However, the same keyword may appear in different content items. Therefore, a generality is not impaired by the simplification as above, and the same advantage as that in the present disclosure is expected to be obtained in a common environment for viewing broadcasting. For example, the keyword “Osaka Jaguars” may be included not only in the metadata assigned to the content item “Come on! Osaka” but in metadata assigned to content items such as “Sport broadcasting Osaka vs. Tokyo” and “Sports news.” Therefore, the generality is not impaired even with the assumption that the same content item is broadcasted 50 times per month and the user views the same content item plural times every month.

In Embodiment 1, the description was given using a recommendation based on a targeting rule corresponding to the keyword having the highest degree of interest, but a recommending method is not limited to be based on such a targeting rule (recommending method). For example, a recommending method in which the degree of importance of the keyword has an influence may be employed. That is, a recommending method such as a content-based filtering which accumulates an interest vector of the user as a user profile and recommends the most similar recommended item obtained as a result of comparing vectors of a user profile and the recommended item.

It is to be noted that although the time when the keyword newly appears in the target content counting unit 20 is the time when the content item becomes available for the first time in Embodiment 1, the time when the keyword newly appears is not limited to this timing, but may be the time when the number of broadcastings of the content item having metadata including the keyword reaches or exceeds a predetermined number. For example, since both of “Yokohama Bayboys” and “Osaka Jaguars” are names of sport teams, the time when the new keyword “Yokohama Bayboys” newly appeared may be the time when the number of appearances of “Yokohama Bayboys” reaches 10 percent of the average number of appearances of “Osaka Jaguars” which is an existing keyword in the same category. Accordingly, a keyword which newly appeared once but never appears after that can be excluded from the calculation of the IDF value.

It is to be noted that the base of the logarithm (Log) in Expression 3 which is for calculating the IDF value may be any number. Specifically, “10,” “2,” or the base of natural logarithm “e” may be used selectively as the base of the logarithm (Log).

It is to be noted that a program for calculating the infrequency of appearance (IDF value) according to the present disclosure may be implemented as a program stored in a television, or a program transmitted to the television from a server via a network connector and executed in the television. Alternatively, the program may be implemented as a program recorded on a recording medium and executed in the television as a result of the television reading the recording medium. Moreover, the program may be implemented as a program which causes a server to operate as the infrequency calculating device according to the present disclosure.

It is to be noted that Embodiment 1 and the other embodiments provide exemplary applications in which the degree of interest of the user is estimated using the infrequency of appearance (IDF value) obtained by the infrequency calculating device, the infrequency calculating method, and the infrequency calculating program according to the present disclosure, and advertisements that are optimized for each user based on the estimation are displayed. However, the infrequency calculating device, the infrequency calculating method, and the infrequency calculating program appropriately calculate the infrequency of appearance of the newly appeared keyword, and thus can be widely applied for the calculation of the infrequency of appearance of the keyword.

As described above, a non-limiting embodiment and other embodiments are provided which the applicant regards as the best mode, with the appended drawings and detailed descriptions. These are provided to a person skilled in the art for the purpose of exemplifying the subject recited in the Claims with reference to a specific embodiment. Thus, the constituent elements described in the appended drawings and the detailed descriptions may include not only constituent elements essential to solve the technical problem but constituent elements other than the essential constituent elements. Therefore, the inessential constituent elements should not be regarded as essential only because they are described in the appended drawings and the detailed descriptions. Moreover, various modifications, replacement, addition, omission, etc. are possible to the above-described embodiments within the scope of the Claims and the equivalents thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure is applicable to, for example, a device which recommends a recommended item according to an interest of the user. Specifically, the present disclosure is applicable to a television, a tablet, a smart phone, and others. Because an estimation of the interest of the user is enabled, the present disclosure is applicable to a device which counts statistics of the interest of the user. Furthermore, the present disclosure is applicable to various applications which require an appropriate calculation of the infrequency of appearance of a newly appeared keyword.

1. An infrequency calculating device, comprising:
an obtaining unit configured to obtain a target keyword from a content item;
a target content counting unit configured to count the number of target content items which satisfy a condition corresponding to the target keyword, among a plurality of content items including the content item;
a specific content counting unit configured to count the number of specific content items including the target keyword, among the target content items; and
an infrequency calculating unit configured to calculate an infrequency of appearance of the target keyword based on the number of target content items and the number of specific content items.

2. The infrequency calculating device according to claim 1,
wherein the plurality of content items include content items that newly appear over time,
the condition corresponding to the target keyword is that a current content item appears during a period from when a content item including the target keyword appeared till when the target content counting unit counts the number of target content items, and
the target content counting unit is configured to count, as the number of target content items, the number of content items that appeared during the period as the number of target content items, among the plurality of content items.

3. The infrequency calculating device according to claim 1,
wherein the plurality of content items include a content item that newly appears over time,
the condition corresponding to the target keyword is that a current content item appears during a period from when a predetermined number of content items including the target keyword appeared till when the target content counting unit counts the number of target content items, and
the target content counting unit is configured to count, as the number of target content items, the number of content items that appeared during the period as the number of target content items, among the plurality of content items.

4. The infrequency calculating device according to claim 1,
wherein the infrequency calculating unit is configured to calculate the infrequency of appearance of the target keyword using a ratio between the number of target content items and the number of specific content items.

5. The infrequency calculating device according to claim 1,
wherein the infrequency of appearance of the target keyword is a term frequency-inverse document frequency (TF-IDF) value of the target keyword, and
the infrequency calculating unit is configured to calculate the TF-IDF value of the target keyword by Expressions 1, 2, and 3, where A is the number of target content items, B is the number of specific content items, C is the number of target keywords included in the target content items, and D is the number of terms included in the plurality of content items.
IDF value=Log(A/B) (Expression 1)
TF value=C/D (Expression 2)
TF-IDF value=TF value×IDF value (Expression 3)

6. An infrequency calculating method, comprising:
obtaining a target keyword from a content item;
counting the number of target content items which satisfy a condition corresponding to the target keyword, among a plurality of content items including the content item;
counting the number of specific content items including the target keyword, among the target content items; and
calculating an infrequency of appearance of the target keyword based on the number of target content items and the number of specific content items.

7. A non-transitory computer-readable recording medium, having a program recorded thereon for causing a computer to execute the infrequency calculating method according to claim 6.

8. An interest degree calculating device, comprising:
the infrequency calculating device according to claim 1;
a number-of-viewings obtaining unit configured to obtain the number of viewings which is the number of times a user viewed the specific content items; and
an interest degree calculating unit configured to calculate a degree of interest of the user in the specific content items based on the infrequency of appearance calculated by the infrequency calculating device and the number of viewings obtained by the number-of-viewings obtaining unit.

9. An interest degree calculating method, comprising:
the infrequency calculating method according to claim 6;
obtaining the number of viewings which is the number of times a user viewed the specific content items; and
calculating a degree of interest of the user in the specific content items based on the infrequency of appearance calculated by the infrequency calculating method and the number of viewings obtained in the obtaining of the number of viewings.

10. A non-transitory computer-readable recording medium, having a program recorded thereon for causing a computer to execute the interest degree calculating method according to claim 9.
